(19) United States
(12) Patent Application Publication
(10) Pub. No.: US 2009/0089402 A1
(43) Pub. Date: Apr. 2, 2009

(54) GRAPHICAL DISPLAY SYSTEM FOR A HUMAN-MACHINE INTERFACE

(76) Inventors: Bruce Gordon Fuller, Edmonton (CA); Brian Alexander Wall, White Rock (CA); Kevin George Gordon, Vancouver (CA); Mark David Hobbs, Hartford, WI (US); Mohamed Salehmohamed, Surrey (CA)

Correspondence Address: ROCKWELL AUTOMATION, INC/SR, 1202 SOUTH SECOND STREET, MAIL STOP E-7F19, MILWAUKEE, WI, 53204, US

(21) Appl. No.: 11/864,398

(22) Filed: Sep. 28, 2007

(51) Int. Cl. G06F 15/16

(52) U.S. Cl. 709/219

(57) ABSTRACT

A graphical display system comprises a Human-Machine Interface (HMI) system and a communication device. The HMI system processes status data from a plurality of machine systems to generate graphical displays indicating status of the machine systems. The HMI system is receives selection information indicating the communication device and a selected set of the graphical displays. The HMI system transfers HMI interface software based on the selection information. The communication device receives and processes the HMI interface software to transfer a display request for the selected set of the graphical displays. The HMI system receives and processes the display request to transfer the selected set of the graphical displays. The communication device receives and displays the selected set of the graphical displays.

### TECHNICAL FIELD

The invention is related to the field of human-machine interfaces, and in particular, to a system that provides user-selected graphical displays that are generated by a human-machine interface through a user-selected communication device.

### TECHNICAL BACKGROUND

Industrial environments include automobile manufacturing factories, food processing plants, and microprocessor fabrication facilities. The typical industrial environment includes various machines, such as pumps, motors, and robots. These machines continually produce data that indicates the current status of the machines, such as the machine's pressure, temperature, or speed.

The typical industrial environment also includes a Human-Machine Interface (HMI). The HMI receives and processes the status data from the machines to generate various graphical displays. The graphical displays indicate the current and historical status of the machines. For example, an HMI graphical display might indicate the pressure of a pump, the speed of a motor, or the output of a robot. The HMI may also control the machines. For example, the HMI might turn on a pump, speed-up a motor, or stop a robot.

The HMI may allow a user to remotely access a graphical display. The user operates a communication device to retrieve a graphical display from the HMI over a communication network. Unfortunately, the user must operate the communication device to connect to the HMI and then navigate through HMI menus to obtain the selected graphical display. This connection and navigation may be too complex and cumbersome for some users.

### TECHNICAL SUMMARY

A graphical display system comprises a Human-Machine Interface (HMI) system and a communication device. The HMI system is configured to process status data from a plurality of machine systems to generate graphical displays indicating status of the machine systems. The HMI system is configured to receive user information indicating the communication device and a selected set of the graphical displays. The HMI system is configured to transfer HMI interface software based on the selection information. The communication device is configured to receive and process the HMI interface software to transfer a display request for the selected set of the graphical displays. The HMI system is configured to receive and process the display request to transfer the selected set of the graphical displays. The communication device is configured to receive and display the selected set of the graphical displays.

In some examples, the communication device is configured to display the selected set of the graphical displays as a series of thumbnail displays.

In some examples, the communication device is configured to receive a user selection of one of the thumbnail displays and display the one of the graphical displays associated with the selected one of the thumbnail displays.

In some examples, the communication device is configured to receive a scroll command to move through the series of the thumbnail displays to the selected one of the thumbnail displays.

In some examples, the communication device is configured to process the HMI interface software to periodically transfer additional display requests for the selected set of the graphical displays. The HMI system is configured to process the additional display requests to transfer updated versions of the selected set of the graphical displays. The communication device is configured to receive and display the updated versions of the selected set of the graphical displays.

In some examples, the communication device is configured to display the updated versions of the selected set of the graphical displays as a series of thumbnail displays, receive a scroll command to move through the series of the thumbnail displays to a selected one of the thumbnail displays, and display the updated version of the one of the graphical displays associated with the selected one of the thumbnail displays.

In some examples, the communication device comprises a wireless Internet-access communication device.

A method provides graphical displays that indicate status of a plurality of machine systems, where an HMI system processes status data from the machine systems to generate the graphical displays. The method comprises, in the HMI system, receiving selection information indicating a selected communication device and a selected set of the graphical displays and transferring HMI interface software from the HMI system based on the selection information. The method comprises, in the communication device, receiving and processing the HMI interface software to transfer a display request for the selected set of the graphical displays. The method comprises, in the HMI system, receiving and processing the display request to transfer the selected set of the graphical displays. The method comprises, in the communication device, receiving and displaying the selected set of the graphical displays.

A software product provides graphical displays that indicate status of a plurality of machine systems, where an HMI system processes status data from the machine systems to generate the graphical displays. The software product comprises HMI operation software, HMI interface software, and a memory device that stores the HMI operation software and the HMI interface software. The HMI operation software is configured to direct HMI system processing circuitry to receive selection information indicating a selected communication device and a selected set of the graphical displays and transfer HMI interface software from the HMI system based on the selection information. The HMI interface software is configured to direct communication device processing circuitry to transfer a display request for the selected set of the graphical displays. The HMI operation software is configured to direct the HMI system processing circuitry to receive and process the display request to transfer the selected set of the graphical displays. The HMI interface software is configured to direct the communication device processing circuitry to receive and display the selected set of the graphical displays.

### BRIEF DESCRIPTION OF THE DRAWINGS

FIG. 1 is a block diagram illustrating a graphical display system.

FIG. 2 is a block diagram illustrating an HMI system.

FIG. 3 is a block diagram illustrating a communication device.

FIG. 4 is a sequence diagram illustrating the operation of a graphical display system.

FIG. 5 is a sequence diagram illustrating the operation of a graphical display system.

FIG. 6 is a display diagram illustrating an HMI system display.

FIG. 7 is a display diagram illustrating an HMI system display.

FIG. 8 is a display diagram illustrating a communication device display.

### DETAILED DESCRIPTION

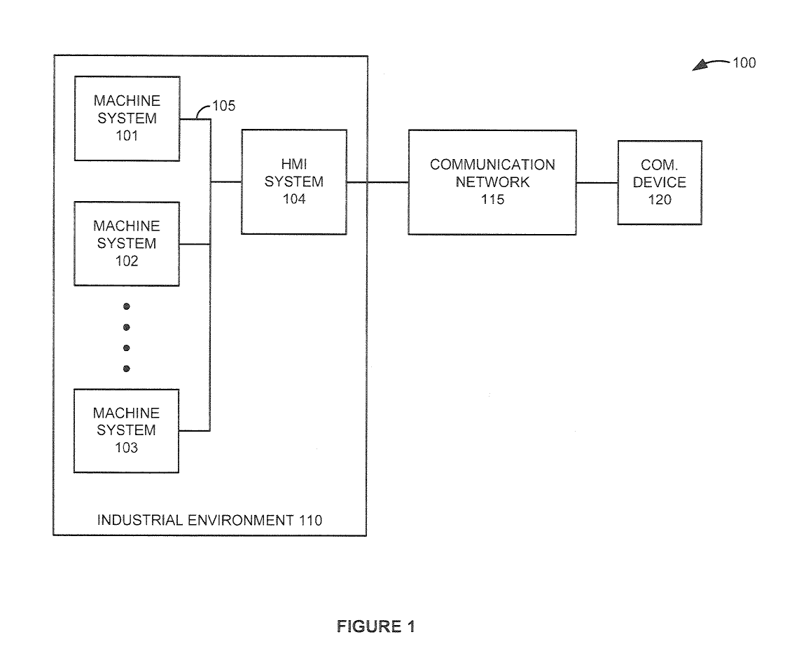

FIG. 1 is a block diagram illustrating graphical display system 100. Graphical display system 100 comprises machine systems 101-103, Human-Machine Interface (HMI) system 104, communication system 105, communication network 115, and communication device 120. The number of machine systems and communication devices shown in FIG. 1 has been restricted for clarity, but there would typically be many more. Machine systems 101-103 and HMI system 104 communicate over communication system 105. HMI system 104 and communication device 120 communicate over communication network 115.

Industrial environment 110 includes machine systems 101-103, HMI system 104, and communication system 105. Industrial environment 110 comprises an automobile manufacturing factory, food processing plant, microprocessor fabrication facility, or some other type of industrial enterprise. Machine systems 101-103 comprise pumps, motors, robots, or some other mechanical apparatus, including their associated control systems. Machine systems 101-103 continually produce status data over time. The status data indicates the current status of machine systems 101-103, such as pressure, temperature, speed, or some other status metrics. Machine systems 101-103 continually transfer the status data to HMI system 104 over communication system 105. Communication system 105 could be a local area network, wide area network, or some other data network.

HMI system 104 comprises computer and communication equipment and software. HMI system 104 continually receives the status data from machine systems 101-103. HMI system 104 processes the status data to generate various graphical displays indicating the current and historical status of machine systems 101-103. For example, an HMI graphical display might indicate the pressure of a pump, the speed of a motor, the output of a robot, or some other status metric. HMI system 104 also controls machine systems 101-103. For example, HMI system 104 might turn on a pump, speed-up a motor, stop a robot, or perform some other type of machine control. An example of an HMI system that could be adapted in accord with this description is RSView™ supplied by Rockwell Automation.

Communication network 115 uses the internet protocol, Ethernet, telephony, or some other communication protocol, including combinations thereof. Communication network 115 uses wireless links, metallic links, optical links, or some other communication link, including combinations thereof. Communication network 115 comprises the Internet, a private network, a telephone network, or some other communication network, including combinations thereof.

Communication device 120 comprises a telephone, wireless transceiver, computer, digital assistant, Internet appliance, or some other communication apparatus. Communication device 120 retrieves selected graphical displays from HMI system 104. Communication device 120 displays the selected graphical displays.

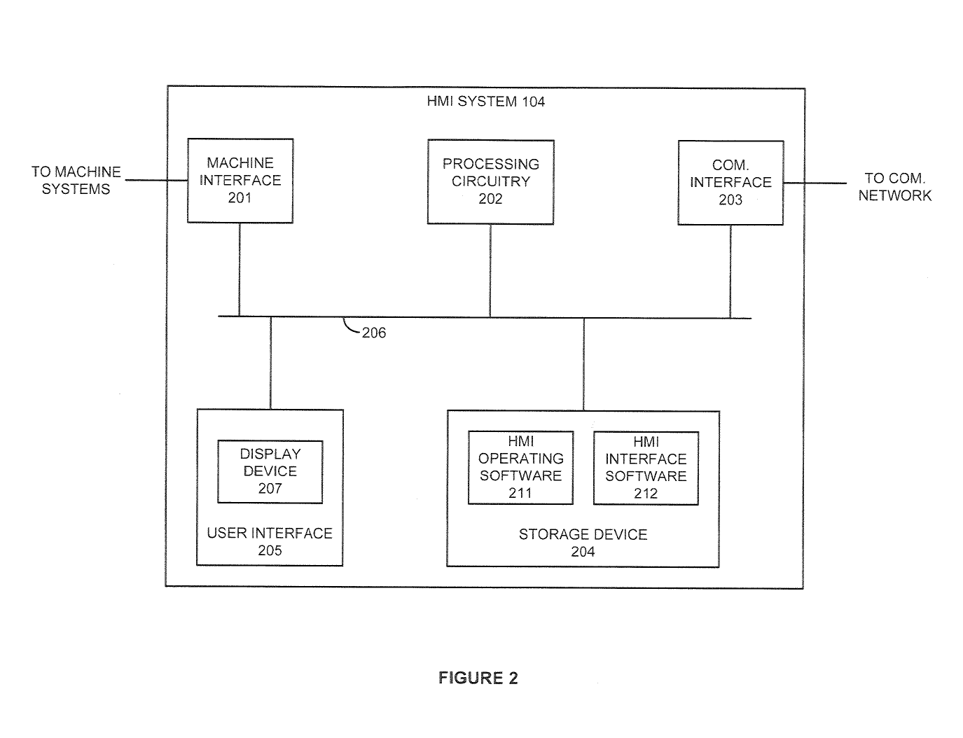

FIG. 2 is a block diagram illustrating HMI system 104. HMI system 104 comprises machine interface 201, processing circuitry 202, communication interface 203, storage device 204, user interface 205, and communication system 206. User interface 205 includes display device 207. Storage device 204 stores HMI operating software 211 and HMI interface software 212.

Machine interface 201 comprises communication circuitry and equipment that communicates with machine systems 101-103 over communication system 105. Processing circuitry 202 comprises microprocessors or other logic circuitry that retrieves and executes HMI operating software 211. Communication interface 203 comprises communication circuitry and equipment that communicates with communication devices over communication network 115. User interface 205 comprises a keyboard, mouse, voice recognition interface, touch screen, or some other user device. Display device 207 comprises a liquid crystal display, cathode ray tube display, or some other graphical display mechanism. Storage device 204 comprises a disk, integrated circuit, flash drive, or some other memory device. Communication system 206 comprises a bus, local area network, or some other communication apparatus. The above-described components (201-206) of HMI system 104 may be integrated together or distributed among multiple devices.

HMI software 211-212 comprises an application program, firmware, or some other form of machine-readable processing instructions. HMI operating software 211 may include an operating system, utilities, drivers, networking, and applications. When executed by processing circuitry 202, HMI operating software 211 directs HMI system 104 to operate as described herein. HMI interface software 211 comprises an application.

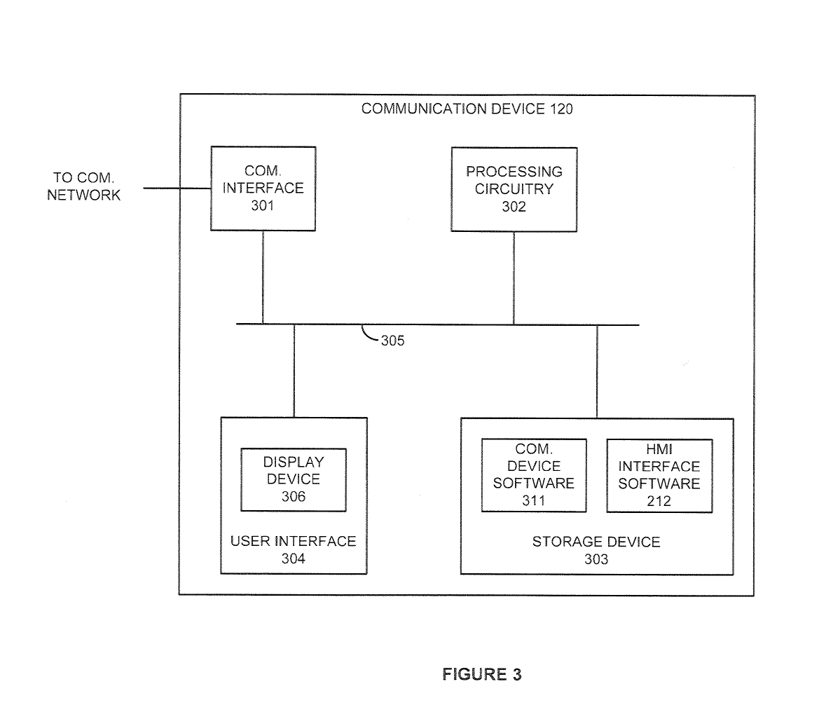

FIG. 3 is a block diagram illustrating communication device 120. Communication device 120 comprises communication interface 301, processing circuitry 302, storage device 303, user interface 304, and communication system 305. User interface 304 includes display device 306. Storage device 303 stores communication device software 311 and HMI interface software 212.

Communication interface 301 comprises communication circuitry and equipment that communicates with HMI system 104 over communication network 115. Processing circuitry 302 comprises microprocessors or other logic circuitry that retrieves and executes communication device software 311 and HMI interface software 212. Storage device 303 comprises a disk, integrated circuit, flash drive, or some other memory device. User interface 304 comprises a keyboard, mouse, voice recognition interface, touch screen, or some other user device. User interface 304 may also include a touch pad, wheel, or some other mechanism that allows a user to input a scroll command. Display device 306 comprises a liquid crystal display, cathode ray tube display, or some other graphical display mechanism. Communication system 305 comprises a bus, communication circuitry, or some other communication apparatus. The above-described components (301-305) of communication device 120 may be integrated together or distributed among multiple devices.

Communication device software 311 comprises an application program, firmware, or some other form of machine-readable processing instructions. Communication device software 311 may include an operating system, utilities, drivers, networking, and applications. When executed by processing circuitry 302, HMI interface software 212 and communication device software 311 direct communication system 120 to operate as described herein.

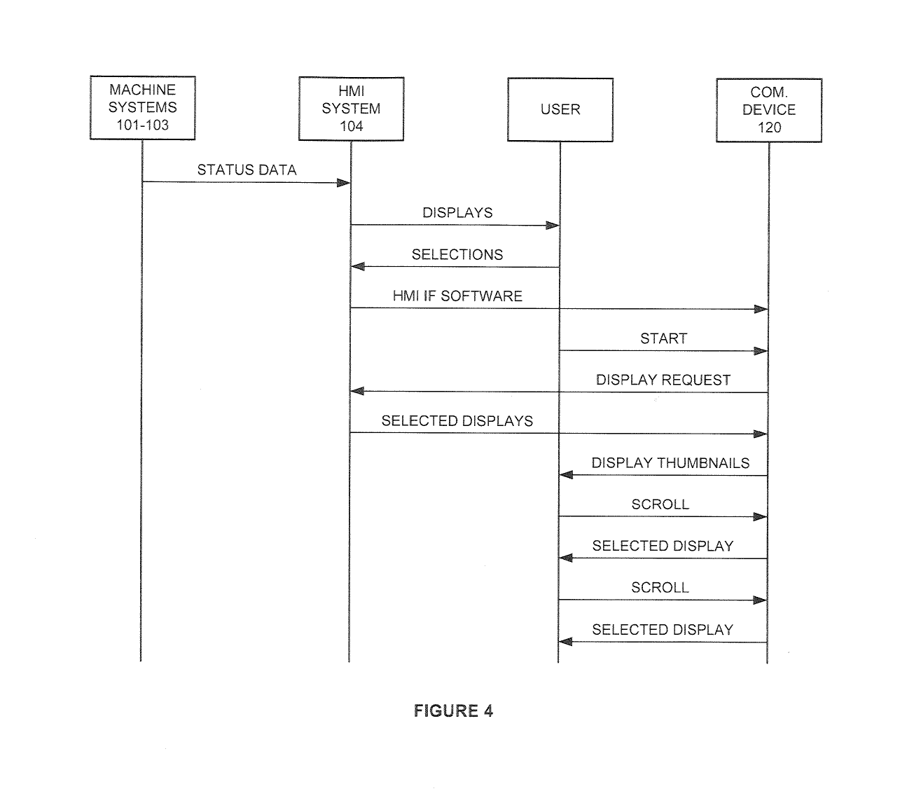

FIG. 4 is a sequence diagram illustrating the operation of graphical display system 100. Machine systems 101-103 transfer status data to HMI system 104. HMI system 104 receives and processes the status data to generate graphical displays that indicate the status of machine systems 101-103. HMI system 104 provides the graphical displays to the user.

The user desires to conveniently access a selected set of the graphical displays from a remote communication device. The user operates HMI system 104 to select the specific graphical displays and the communication device for remote access. In response to the user selections, HMI system 104 generates HMI interface software 212 including the identity of the selected displays. The displays could be identified by file name, uniform resource locator, or some other display identifier. HMI system 104 transfers HMI interface software 212 to the selected communication device—communication device 120 in this example.

The user then operates communication device 120 to start HMI interface software 212. In response, communication device 120 transfers a request for the selected displays to HMI system 104. HMI system 104 transfers the selected graphical displays to communication device 120. Communication device 120 displays the selected displays in a series of thumbnail displays. Thumbnail displays are relatively small (thumbnail or smaller) versions of the graphical displays that are sized to fit several of the thumbnail displays on display device 306.

The user operates communication device 120 to scroll through the thumbnail displays to a selected one of the thumbnail displays. In response, communication device 120 displays the graphical display represented by the selected thumbnail display. The resulting graphical display is typically several times larger than the selected thumbnail display. The user may then operate communication device 120 to again scroll through the thumbnail displays to another one of the thumbnail displays. In response, communication device 120 displays the other graphical display that is represented by the other thumbnail display.

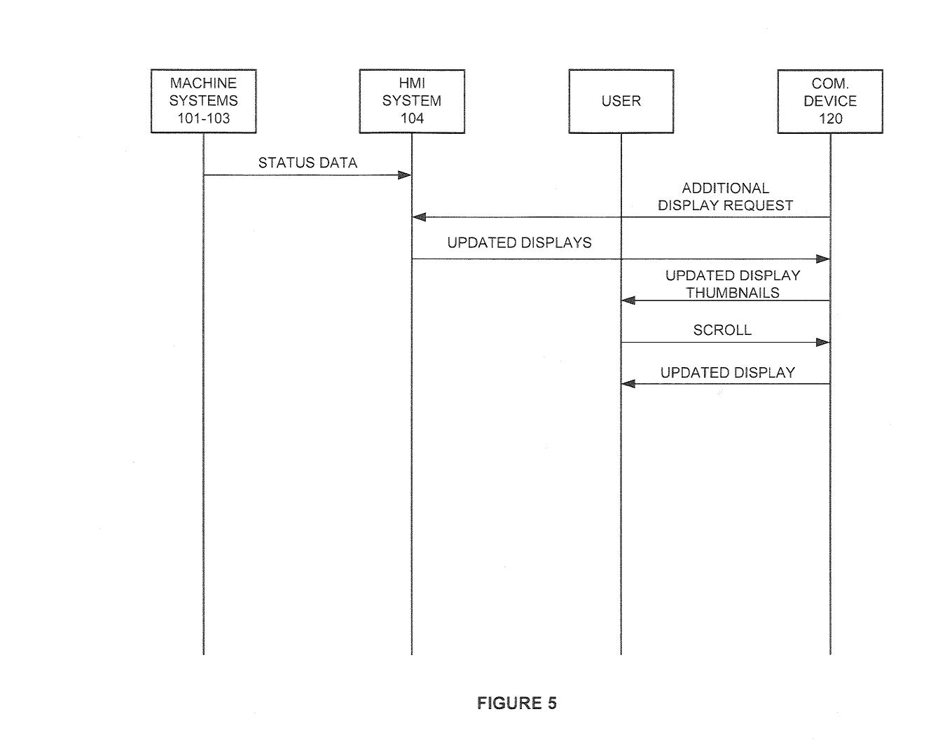

FIG. 5 is a sequence diagram illustrating the operation of graphical display system 100. Machine systems 101-103 continue to transfer additional status data to HMI system 104. HMI system 104 receives and processes the additional status data to generate updated graphical displays that indicate the updated status and history of machine systems 101-103. In response to HMI interface software 212, communication device 120 periodically transfers additional requests for the selected displays to HMI system 104. HMI system 104 transfers the updated graphical displays to communication device 120. Communication device 120 displays the updated graphical displays in a series of thumbnail displays. The user operates communication device 120 to scroll through the updated thumbnail displays to a selected one of the thumbnail displays. In response, communication device 120 displays the updated graphical display depicted by the selected thumbnail display.

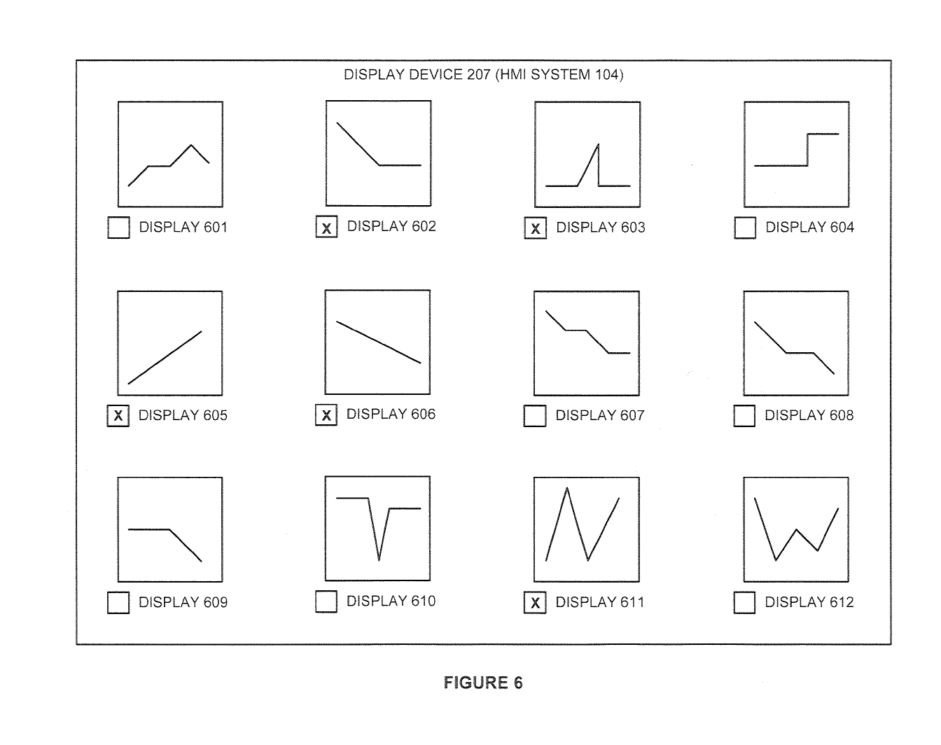

FIG. 6 is a display diagram illustrating an HMI system 104 display provided by display device 207. HMI system 104 provides the display when the user desires to conveniently access a set of the graphical displays from a remote communication device. The display depicts several graphical displays 601-612 along with associated selection boxes. Note that displays 601-612 are illustrative and do not depict actual HMI graphical displays. The user selects displays by checking the desired boxes. In this example, graphical displays 602, 603, 605, 606, and 611 are selected. In response, HMI system 104 loads identifiers for the selected displays into HMI interface software 212 for transfer to the selected communication device.

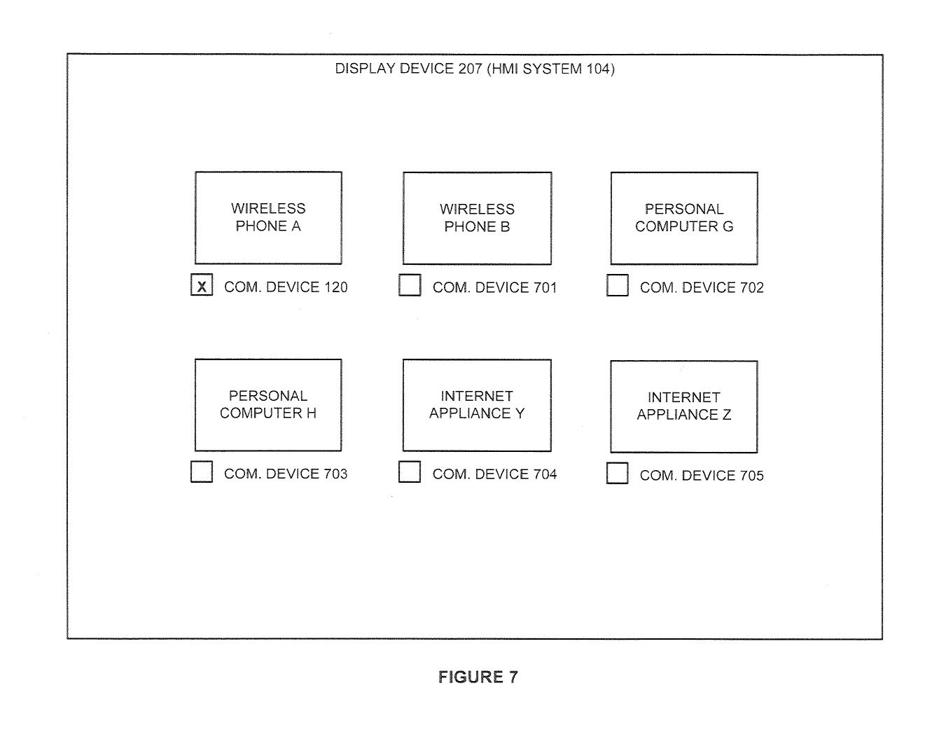

FIG. 7 is a display diagram illustrating an HMI system 104 display provided by display device 207. HMI system 104 provides the display when the user desires to conveniently access a set of the graphical displays from a remote communication device. The display depicts several communication devices 120 and 701-705 along with associated selection boxes. The user selects one or more of the communication devices by checking the desired boxes. In this example, communication device 120 is selected and is a wireless telephone, although other communication devices could have been selected. In response, HMI system 104 transfers the resulting HMI interface software 212 with the selected display identifiers to selected communication device 120.

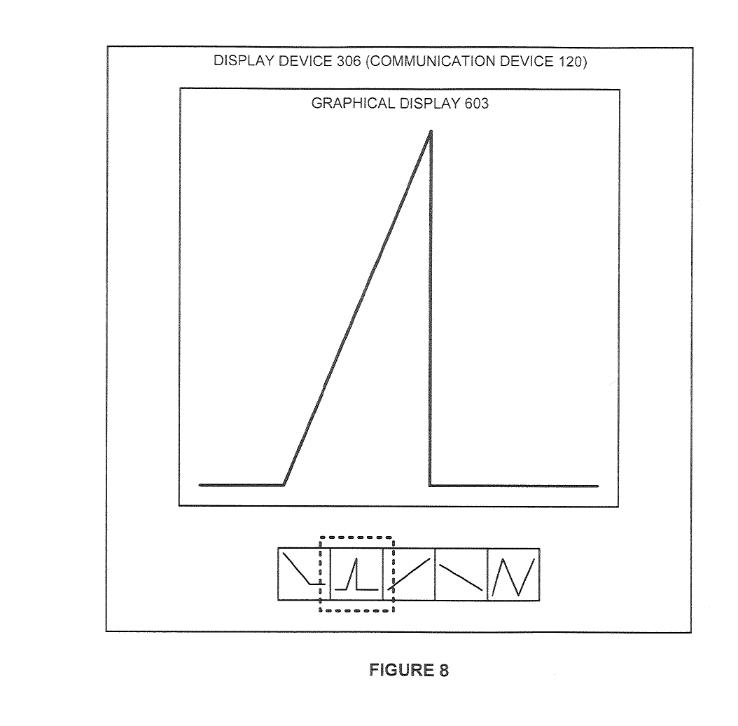

FIG. 8 is a display diagram illustrating a communication device 120 display provided by display device 306. At the bottom, display device 306 depicts a series of thumbnail displays for the selected graphical displays 602, 603, 605, 606, and 611. The user has operated user interface 304 to scroll to a selected thumbnail display (indicated on FIG. 8 by the dashed square). The selected thumbnail display represents graphical display 603. In response to the user scroll, communication device 120 drives display device 306 to present graphical display 603. If the user scrolls to a new thumbnail display, then communication device 120 would drive display device 306 to present the corresponding graphical display.

Note that HMI system 104 may be configured to detect a specified condition and issue a corresponding alarm. For example, HMI system 104 may issue an alarm if a motor exceeds a given temperature. HMI system 104 may also be configured to indicate the alarm on some of the graphical displays. For example, HMI system 104 could blink a graphical display red in response to an alarm related to the display. Advantageously, graphical display system 100 promptly informs a remote user of the alarm, since the thumbnail display on the user's communication device would also indicate the alarm—possibly by blinking red. The user could then quickly scroll to the blinking thumbnail display to investigate the alarm from their remote location.

Advantageously, the user is able to easily select a set of displays from HMI system 104 for display on a user-selected communication device. The user is also able to see many or all of the selected displays on the communication device in a thumbnail representation. The user may then conveniently scroll to a selected thumbnail display to have the corresponding graphical display rendered on the communication device screen. In addition, the communication device continually updates the displays and provides alarms. Thus, the user may conveniently establish and obtain a remote and current view of their desired HMI graphical displays.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method of providing graphical displays that indicate status of a plurality of machine systems wherein a Human-Machine Interface (HMI) system processes status data from the machine systems to generate the graphical displays, the method comprising:
receiving selection information indicating a selected communication device and a selected set of the graphical displays;
transferring HMI interface software from the HMI system based on the selection information for delivery to the communication device;
receiving and processing a display request transferred from the communication device to transfer the selected set of the graphical displays; and
transferring for delivery to the communication device the selected set of the graphical displays.

2. The method of claim 1 further comprising, in the communication device, receiving and processing the HMI interface software to transfer the display request for the selected set of the graphical displays, and receiving and displaying the selected set of the graphical displays as a series of thumbnail displays.

3. The method of claim 2 wherein displaying the selected set of the graphical displays comprises receiving a user selection of one of the thumbnail displays and displaying the one of the graphical displays associated with the selected one of the thumbnail displays.

4. The method of claim 3 wherein receiving the user selection of one of the thumbnail displays comprises receiving a scroll command to move through the series of the thumbnail displays to the selected one of the thumbnail displays.

5. The method of claim 1 further comprising:
in the communication device, processing the HMI interface software to periodically transfer additional display requests for the selected set of the graphical displays;
in the HMI system, processing the additional display requests to transfer updated versions of the selected set of the graphical displays; and
in the communication device, receiving and displaying the updated versions of the selected set of the graphical displays.

6. The method of claim 5 wherein displaying the updated versions of the selected set of the graphical displays comprises displaying the updated versions of the selected set of the graphical displays as a series of thumbnail displays, and further comprising receiving a scroll command to move through the series of the thumbnail displays to a selected one of the thumbnail displays and displaying the updated version of the one of the graphical displays associated with the selected one of the thumbnail displays.

7. The method of claim 1 wherein the communication device comprises a wireless Internet-access communication device.

8. A graphical display system comprising:
a communication device;
a Human-Machine Interface (HMI) system configured to process status data from a plurality of machine systems to generate graphical displays indicating status of the machine systems, receive selection information indicating the communication device and a selected set of the graphical displays, and transfer HMI interface software based on the selection information; and
the communication device configured to receive and process the HMI interface software to transfer a display request for the selected set of the graphical displays;
the HMI system configured to receive and process the display request to transfer the selected set of the graphical displays; and
the communication device configured to receive and display the selected set of the graphical displays.

9. The graphical display system of claim 8 wherein the communication device is configured to display the selected set of the graphical displays as a series of thumbnail displays.

10. The graphical display system of claim 9 wherein the communication device is configured to receive a user selection of one of the thumbnail displays and display the one of the graphical displays associated with the selected one of the thumbnail displays.

11. The graphical display system of claim 10 wherein the communication device is configured to receive a scroll command to move through the series of the thumbnail displays to the selected one of the thumbnail displays.

12. The graphical display system of claim 8 wherein:
the communication device is configured to process the HMI interface software to periodically transfer additional display requests for the selected set of the graphical displays;
the HMI system is configured to process the additional display requests to transfer updated versions of the selected set of the graphical displays; and the communication device is configured to receive and display the updated versions of the selected set of the graphical displays.

13. The graphical display system of claim 12 wherein the communication device is configured to display the updated versions of the selected set of the graphical displays as a series of thumbnail displays, receive a scroll command to move through the series of the thumbnail displays to a selected one of the thumbnail displays, and display the updated version of the one of the graphical displays associated with the selected one of the thumbnail displays.

14. The graphical display system of claim 8 wherein the communication device comprises a wireless Internet-access communication device.

15. A software product to provide graphical displays that indicate status of a plurality of machine systems wherein a Human-Machine Interface (HMI) system processes status data from the machine systems to generate the graphical displays, the software product comprising:
HMI operation software configured to direct HMI system processing circuitry to receive selection information indicating a selected communication device and a selected set of the graphical displays and transfer HMI interface software from the HMI system based on the selection information; and
the HMI interface software configured to direct communication device processing circuitry to transfer a display request for the selected set of the graphical displays;
the HMI operation software configured to direct the HMI system processing circuitry to receive and process the display request to transfer the selected set of the graphical displays;
the HMI interface software configured to direct the communication device processing circuitry to receive and display the selected set of the graphical displays; and
a memory device that stores the HMI operation software and the HMI interface software.

16. The software product of claim 15 wherein the HMI interface software is configured to direct the communication device processing circuitry to receive and display the selected set of the graphical displays as a series of thumbnail displays.

17. The software product of claim 16 wherein the HMI interface software is configured to direct the communication device processing circuitry to receive a user selection of one of the thumbnail displays and display the one of the graphical displays associated with the selected one of the thumbnail displays.

18. The software product of claim 17 wherein the HMI interface software is configured to direct the communication device processing circuitry to receive a scroll command to move through the series of the thumbnail displays to the selected one of the thumbnail displays.

19. The software product of claim 15 wherein:
the HMI interface software is configured to direct the communication device processing circuitry to periodically transfer additional display requests for the selected set of the graphical displays;
the HMI operation software is configured to direct the HMI system processing circuitry to process the additional display requests to transfer updated versions of the selected set of the graphical displays; and
the HMI interface software is configured to direct the communication device processing circuitry to receive and display the updated versions of the selected set of the graphical displays.

20. The software product of claim 19 wherein the HMI interface software is configured to direct the communication device processing circuitry to display the updated versions of the selected set of the graphical displays as a series of thumbnail displays, receive a scroll command to move through the series of the thumbnail displays to a selected one of the thumbnail displays, and display the updated version of the one of the graphical displays associated with the selected one of the thumbnail displays.

21. A Human-Machine Interface (HMI) system to provide graphical displays that indicate status of a plurality of machine systems, the HMI system comprising:
a machine system interface configured to receive status data from the plurality of machine systems;
processing circuitry configured to process the status data to generate the graphical displays; and
a communication interface configured to receive selection information indicating a selected communication device and a selected set of the graphical displays, transfer HMI interface software from the HMI system based on the selection information for delivery to the communication device, receive and process a display request transferred from the communication device to transfer the selected set of the graphical displays, and transfer for delivery to the communication device the selected set of the graphical displays.
